(19) United States
(12) Patent Application Publication
(10) Pub. No.: US 2022/0113244 A1
(43) Pub. Date: Apr. 14, 2022

(54) SYSTEM AND METHOD FOR DETECTING A PRESENCE OF A PARTICLE IN A FLUID

(71) Applicant: Christoph LANGHAMMER, Göteborg (SE)

(72) Inventors: Christoph LANGHAMMER, Göteborg (SE); Joachim FRITZSCHE, Göteborg (SE); Barbora SPACKOVA, Göteborg (SE)

(73) Assignee: Christoph LANGHAMMER, Göteborg (SE)

(21) Appl. No.: 17/430,432

(22) PCT Filed: Jan. 31, 2020
(86) PCT No.: PCT/EP2020/052499

§ 371 Date: Aug. 12, 2021

(30) Foreign Application Priority Data
Feb. 12, 2019 (SE) 1950168-3

(51) Int. Cl. G01N 15/14

(52) U.S. Cl. CPC G01N 15/1484; G01N 2015/1006; G01N 15/1459

(57) ABSTRACT

A system for label-free detection of a presence of a particle in a fluid comprises: a nanochannel configured to receive the fluid, a light source, a light sensor, arranged to determine an amount of scattered light from a section of the nanochannel. The light being scattered by the section of the nanochannel, the fluid in the section of the nanochannel, and, if present in the section of the nanochannel, the particle. A processing unit arranged to communicate with the light sensor and to determine the presence of the particle in the fluid in the section of the nanochannel based on received data from the light sensor. A method for determining a presence of a particle in a fluid is also disclosed.

### FIELD OF INVENTION

The present invention relates to a system for detecting a presence of a particle in a fluid.

### TECHNICAL BACKGROUND

Detection of small amounts of particles is important in several different technical fields, such as chemistry, biology, medicine, and environmental monitoring, to name a few. However, the detection of small amounts of particles is typically difficult. There are several methods capable of detecting small amounts of particles or even single particles, however they require labeling, cannot operate at low analyte concentrations and when single particle detection is required, they are incompatible with nanoscopic volumes, or suffer from the need for specific wavelengths of excitation light sources, as well as high costs.

The labeling approach, which is most common, is a method where the particles are labeled with a nanoparticle or a molecule of known characteristics. Usually the particles are then detectable using optical techniques utilizing, e.g., fluorescence. Hence, it is an indirect detection technique, which essentially detects the label attached to the particle itself. The presence of such a label, however, is problematic for a number of reasons. The main drawbacks are that the label itself can change the properties of the target particle and that the measurement rate is limited by the inherently low emission rate of fluorophores, which means that fast processes cannot be measured. Furthermore, it can be difficult and cumbersome to attach the label to the particle to be detected.

Hence, there is a need for improved techniques for particle detection.

### SUMMARY

In view of the above, providing a system and a method for detecting a presence of a particle in a fluid mitigates, alleviates or eliminates one or more of the above-identified drawbacks in the art.

The present concept is based on the realization that the intensity of the light scattered by a nanochannel is highly sensitive to the presence of particles inside the nanochannel. Any object of finite size has the ability to elastically scatter light, since scattering is a fundamental process in light-matter interaction. The intensity of the scattered light (I=I₀σ) is determined by an incident electric field intensity (I₀) and a scattering cross-section (σ) of the object. For three-dimensional particles, whose sizes are much smaller than the wavelength of the incident light (λ) (e.g., molecules or nanoparticles), this process is known as Rayleigh scattering and the scattering cross section is determined by the wavenumber of the light (k) and polarizability of a particle (α) as σ=k⁴/(6π)|α|².

A nanochannel, which is an object having finite (subwavelength) sizes in two dimensions, will scatter light as well. Its scattering cross section is a function of the nanochannel size, shape, and if applicable the relative permittivity of the fluid inside the nanochannel (ε) and the relative permittivity of the material in which the nanochannel is embedded (εₘ). Assuming that the material inside the nanochannel is a fluid comprising additional particles, such as molecules or nanoparticles, defined by their polarizability α=α′+iα″ (α′ and a″ are real and imaginary part of polarizability), the contribution of these particles can be described in terms of their bulk optical properties, i.e., as an effective permittivity

$$ɛ \approx {ɛ}_{f} ( 1 + \frac{n α}{1 - vn α} ) , \qquad Eq . 1$$

where ε_{f} is the relative permittivity of the fluid, n=N/V is the volume density of the particles, and v is a depolarization factor that depends on the shape of the nanochannel. The presence of the particles in the fluid results in a change of the effective permittivity (Δε=ε₂−ε₁), and consequently, in a change of the intensity of the scattered light from the nanochannel.

The scattered light from a nanochannel can for instance be collected by means of conventional microscopy techniques, such as dark-field microscopy. Apart from the desired signal representing the particles, the collected signal (I) (integrated intensity over an imaged spot) contains other contributions, which preferably are eliminated. Generally, the signal contains the light scattered by the nanochannel and the particles to be detected but also an unwanted background signal composed of the dark signal of the detector and light scattered from interfaces between the nanochannel, light source and detector. Furthermore, the spatial fluctuation of the collected total scattering signal generally contains contributions from the particles (their spatial distribution in the nanochannel) but also a contribution associated with inhomogeneous illumination and surface roughness. The latter contribution may be comparable in amplitude with the fluctuations emanating from the particles. The temporal fluctuations of the signal generally contain contributions from the change of the local distribution of the particles (particles appear or disappear from the imaged spot) but also contributions originating from the instability of the light source or mechanical drift. The generally wanted signal representing the detection of the particles can thus be extracted from the normalized signal change, as

$$\overline{Δ I} = \frac{{I}_{2}^{m} / {I}_{1}^{m}}{{I}_{2}^{r} / {I}_{1}^{r}} - 1 \qquad Eq . 2$$

where indexes 1 and 2 correspond to signals collected at different times, and indexes m and r correspond to signals collected from the measurement nanochannel (nanochannel containing the particles) and a reference channel (nanochannel which does not contain the particles), respectively. From each signal, the background signal may be removed. The normalized signal change then corresponds to

$$\overline{Δ I} = \frac{{σ}_{2} - {σ}_{1}}{{σ}_{1}} = S Δ ( n α ) \qquad Eq . 3$$

where S stands for sensitivity. Assuming that the uncertainty in the signal is limited by the noise, the presence of a particle or particles is typically detected when Δ̅I̅ higher than a predetermined threshold value. For instance, the threshold value may be three standard deviations of the noise level. From temporal and spatial series of Δ̅I̅, the spatial and temporal distributions of particles in the nanochannel can thus be determined.

For a nanochannel with circular cross-section with radius r<<λ (Rayleigh limit), the scattering cross section for TM and TE polarization (incident wave with electric field is parallel and perpendicular to the cylindrical axis, respectively) can be determined analytically as

$$σ = \frac{{V}^{2} {k}_{m}^{3}}{4 L} {\vert \frac{ɛ}{{ɛ}_{m}} - 1 \vert}^{2} , for TM polarization \\ σ = \frac{{V}^{2} {k}_{m}^{3}}{2 L} {\vert \frac{ɛ - {ɛ}_{m}}{ɛ + {ɛ}_{m}} \vert}^{2} , for TE polarization \qquad Eq . 4$$

where L is the length of the illuminated part of a nanochannel, V=πr²L is the volume of the illuminated part of a nanochannel, and kₘ is the wavenumber of the light in the material surrounding the nanochannel. Using Eq. 1 (v=0 for TM polarization, v=½ for TE polarization) and Eq. 4 and assuming that the light scattered by the nanochannel is imaged by a diffraction-limited optical system, L=λ/(2NA), where NA is the numerical aperture of the imaging system, and assuming that the contribution of the particles present in the nanochannel is small, i.e., nα<<V (ε_{f}+εₘ)/(ε_{f}−εₘ), the intensity of collected light from a diffraction limited spot can be written as

I≈I_{c}+αIₚ+2 sgn(ε−εₘ)\sqrt{αI_{c}Iₚ′}, 5

where

$$a = \frac{3 NA}{2 {n}_{m}}$$

for TM polarization,

$$a = \frac{3 NA}{2 {n}_{m}} \frac{{ɛ}_{m}^{2}}{{ɛ}^{2}}$$

for TE polarization, I_{c}=I₀σ_{c}, is the collected intensity of the scattered light from a nanochannel without the particles, Iₚ=I₀k⁴/(6π)|Nα|² is intensity of scattered light of the particles when placed in an infinite medium, and Iₚ′=I₀k⁴/(6π)Nα′|². Eq. 5 shows that the intensity of the scattered light is not only the sum of the intensity of the light scattered by the nanochannel and by the particles but that the additional term≈2\sqrt{I_{c}Iₚ}, also sizably contributes to the intensity of scattered light. To this end, the light elastically scattered from small particles is usually impossible to detect directly since their cross section σₚ is very low. However, the third term on the right hand side in Eq. 5 can be larger by several orders of magnitude since the nanochannel can be designed to scatter considerably more (σ_{c}>σₚ). Due to this fact, even small amounts of particles or even individual particles can be detected when placed inside a nanochannel.

Following Eq. 5, the sensitivity (Eq. 3) can be written as

$$S \approx \frac{2 ɛ}{ɛ - {ɛ}_{m}} , for TM polarization \\ S \approx \frac{4 {ɛɛ}_{m}}{{ɛ}^{2} - {ɛ}_{m}^{2}} , for TE polarization . \qquad Eq . 6$$

For nanochannels having other than circular cross sections (ellipsoidal, rectangular) and/or a size beyond the Rayleigh limit, S can be calculated using the numerical finite-difference time-domain method, FDTD. In this way it can be shown that for a nanochannel with its characteristic sizes exceeding the Rayleigh limit, S decreases with the size, and for nanochannels with sizes within the Rayleigh limit, S is approximately equivalent to the case of a nanochannel with a circular cross section and identical cross sectional area. Experimentally, S can be extracted from calibration measurements.

It is to be noted that Eq. 1 neglects the interaction between the particles and the interaction of the particles with the walls of the nanochannel and it is accurate to the first order of the volume fraction (volume of all particles divided by the volume of the nanochannel). Due to this fact, S in Eq. 6 is neither dependent on the position of the particle in the nanochannel nor on the particle density. However, as can be shown using FDTD calculations, due to the interaction between the particles and the interaction of the particles with the walls, polarizability, and corresponding S, slightly change with the distance from the wall, size and density of the particle. Since these dependencies differ for TM and TE, additional information can be deconvoluted from simultaneous independent measurements in TM and TE polarization, e.g., the spatial position of a particle in the nanochannel, or the size and density of the particles attached to the wall.

According to a first aspect a system for detecting a presence of a particle in a fluid is provided. The system comprises: a nanochannel configured to receive the fluid, wherein the fluid comprises a particle; a light source, configured to illuminate the nanochannel; a light sensor, arranged to determine an amount of scattered light from a section of the nanochannel, the light being scattered by the section of the nanochannel, the fluid in the section of the nanochannel, and, if present in the section of the nanochannel, the particle and to output data based on the amount of scattered light; and a processing unit arranged to communicate with the light sensor to receive the data based on the amount of scattered light, and to determine the presence of the particle in the fluid in the section of the nanochannel based on the received data.

The wording “nanochannel” should, within the context of this application, be construed as a fluid channel/fluidic channel having a thickness and a width smaller than a wavelength of light emitted from the light source. A longitudinal length of the nanochannel may be arbitrary. For instance, the longitudinal length of the nanochannel may be larger than the wavelength of light emitted from the light source.

The wording “an amount scattered light from a section of the nanochannel” should, within the context of this application, be construed as all scattered light from the section of the nanochannel. For instance, the amount of scattered light from the section of the nanochannel may comprise light scattered by the section of the nanochannel itself, by the fluid in the section of the nanochannel, and, if present in the section of the nanochannel, by the particle.

By means of the present system it is possible to detect the presence of a particle in a fluid without needing to label the particle or to block light scattered from other objects than the particle. The complexity of the measurement setup may thereby be reduced. Particle labelling, which is typically done in prior art systems, introduces a complexity in the detection method and may change the properties of the particle of interest. Moreover, the measurement speed is limited by the low fluorescent emission and/or lifetime of the label. Therefore, removing the need of particle labelling in the present system may allow for reducing the complexity of the detection method, preserving particle properties and at the same time allow a higher measurement speed.

The present system may further allow for that the resolution of a conventional and label-free optical method becomes sufficient to detect single binding events of middle-size proteins.

The present system may further allow detection of single binding events at extremely low concentrations due to a substantial increase of sensing area. This because the entire inner surface of the section of the nanochannel may act as an active surface. By arranging a plurality (tens to hundreds) of parallel nanochannels the desired effect may be increased. An advantage of arranging a plurality of parallel nanochannels is that the throughput of an amount of fluid that passes through the nanochannels may be improved.

The present system further allows for a sensing surface comprising only one material, which may remove a need for complex orthogonal biofunctionalization. An advantage of removing the need for complex orthogonal biofunctionalization is that it may reduce a complexity of the measurement system further, especially compared to nanoplasmonic systems, where passivation of a dielectric substrate is needed.

By illuminating the nanochannel with two different light polarizations, the present system may further allow for a determination of a refractive index and/or a thickness of a layer of adsorbed particles on an inner surface of the section of the nanochannel.

The present system may further allow for an effective capture and detection of ultrasmall amounts of molecules in extremely small volumes. For example, ultrasmall amounts released by single bacteria or cells. In prior art systems, such small number of molecules is typically lost due to diffusion and immediate extreme dilution, rendering the small number of molecules indetectable in the prior art system.

The nanochannel is configured to receive the fluid. The fluid may be stationary inside the nanochannel. The fluid may be flowing inside the nanochannel. The nanochannel may be at least partially filled with the fluid. In other words, the fluid is inside the nanochannel. The nanochannel may be made of, or embedded in, a material transparent to light emitted from the light source. The nanochannel may be made of, or embedded in, a dielectric material. The nanochannel may be inscribed in a semiconducting material. The nanochannel may be a hollow-core optical fiber or a capillary. At least a portion of an internal wall of the nanochannel may comprise an additional layer. The additional layer may comprise a biofunctional layer, catalytic particles, photoactive molecules, polymer molecules, and/or a functional oxide. The fluid comprises a particle. The fluid may comprise a liquid and/or a gas or a mixture of both. The fluid may be one or more of water, a buffer, ethanol, an organic solvent, a serum, cytoplasm, aqueous solutions of salts, air, argon, helium, hydrogen, NO, NO₂, and CO. The particle may be an organic molecule, an inorganic molecule, a biological macromolecule, a virus, an extracellular vesicle, an exosome, a bubble in the fluid, a dielectric nanoparticle, a polymer nanoparticle, and/or a metal nanoparticle. The particle may be bound or adsorbed on the inner wall of the nanochannel. The particle may be unbound or desorbed from the inner wall of the nanochannel. The particle may move freely in the fluid.

The system may comprise an array of nanochannels. An advantage of the system comprising an array of nanochannels is that applications utilizing multiplexing may be allowed.

The light source is configured to illuminate the nanochannel. The light source may be configured to illuminate at least a portion of the nanochannel. The light source may emit coherent light. For example, the light source may be a laser or a laser diode. The light source may emit quasi-coherent light. For example, the light source may be a superluminescent diode. The light source may emit incoherent light. For example, the light source may be a halogen lamp. Light emitted from the light source may be polarized.

The light sensor is arranged to determine an amount of scattered light from a section of the nanochannel, the light being scattered by the nanochannel, the fluid in the section of the nanochannel, and, if present in the section of the nanochannel, the particle and to output data based on the amount of scattered light. The light sensor may output data based on the amount of scattered light from the section of the nanochannel that reaches the light sensor. In other words, the light sensor is arranged to detect a portion of light emitted from the light source, which is scattered by the section of the nanochannel, the fluid in the section of the nanochannel, and, if present in the section of the nanochannel, the particle. Thus, the light sensor is arranged to avoid or neglect light, which has not been scattered. For instance, light which has not been scattered may be specularly reflected light or direct light emitted from the light source. The light sensor may comprise an imaging surface. The light sensor may be an imaging type of sensor.

An advantage of arranging the light sensor to determine an amount of scattered light being scattered from the nanochannel, the fluid, and the particle is that no scattered light needs to be blocked or reduced. More specifically, light being scattered from the nanochannel and from the fluid do not need to be blocked and/or reduced (e.g., by filtering) when detecting the presence of the particle in the fluid, which in turn may decrease the complexity of the system.

The processing unit is arranged to communicate with the light sensor and to receive the data based on the amount of scattered light. The processing unit may be arranged to communicate in a wired and/or wireless manner. For instance, the processing unit may communicate with the light sensor by USB, Ethernet, Firewire, Wi-Fi etc. The processing unit is further arranged to determine the presence of the particle in the fluid in the section of the nanochannel based on the received data. The received data is the data based on the amount of scattered light from the section of the nanochannel received by the processing unit. The processing unit may be further arranged to adjust the amount of light emitted from the light source. For instance, the processing unit may communicate to the light source to increase or decrease an amount of light emitted from the light source based on the amount of light detected by the light sensor. The processing unit may be further arranged to determine the presence of the particle in the fluid in the section of the nanochannel based on a change of the received data. The change of the received data may correspond to a difference between a first and a second amount of scattered light from the section of the nanochannel. The first/second amount of scattered light may be scattered light from a first/second portion of the section of the nanochannel. The first/second amount of scattered light may be scattered light from a portion of the section of the nanochannel at a first/second point in time. In other words, the presence of the particle in the fluid in the section of the nanochannel may be based on a differential amount or relative change of scattered light from the section of the nanochannel.

The system may further comprise a reference nanochannel. The reference nanochannel may not comprise a particle. The processing unit may be further arranged to determine the presence of the particle based on a further amount of scattered light from the reference nanochannel.

The processing unit may further be arranged to determine the presence of the particle by comparing the data based on the amount of scattered light pertaining to a first point in time with the data based on the amount of scattered light pertaining to a second point in time, which is advantageous in that the processing unit may determine the presence of the particle, e.g., based on a temporal change of the amount of scattered light. In other words, the presence of the particle in the section of the nanochannel may be determined based on a differential amount or relative change of scattered light from the nanochannel.

The system may further comprise optics arranged to image the section of the nanochannel on an imaging surface of the light sensor.

The optics may comprise a lens. The optics may comprise a camera objective. The optics may be a zoom camera objective. It is to be understood that the optics may comprise other optical components, such as diaphragms, windows and/or optical filters.

An advantage of arranging the optics to image the section of the nanochannel on an imaging surface of the light sensor is that spatial information of the section of the nanochannel may be detected by the light sensor. Thereby, a position of the particle in the section of the nanochannel may be determined. A spatial resolution of the determined position of the particle in the section of the nanochannel may be limited by the spatial resolution of the optics.

The processing unit may be configured to create a digital representation of the imaged section of the nanochannel based on the received data.

The wording “digital representation” should, within the context of this application, be construed as information stored in a digital binary format.

The digital representation of the imaged section of the nanochannel may be processed. For instance, noise in the digital representation may be reduced by temporal or spatial averaging.

An advantage of creating a digital representation of the imaged section of the nanochannel is that the digital representation may be stored and/or processed in a digital manner. Processing the digital representation of the imaged section of the nanochannel in a digital manner is beneficial, since digital processing may increase the sensitivity and/or accuracy of the system.

The processing unit may be further configured to determine, based on the digital representation, a spatial distribution of the scattered light from the section of the nanochannel. The spatial distribution may be a digital image.

An advantage of determining, based on the digital representation, a spatial distribution of the scattered light from the section of the nanochannel is that spatial information of the section of the nanochannel, the fluid in the section of the nanochannel, and/or, if present in the section of the nanochannel, the particle may be extracted from the digital representation. A further advantage of determining, based on the digital representation, a spatial distribution of the scattered light from the section of the nanochannel is that the amount of scattered light from the section of the nanochannel may be correlated with spatial positions of the section of the nanochannel. In other words, it may be possible to determine portions of the section of the nanochannel, which scatters more light than other portions of the section of the nanochannel.

The processing unit may be further configured to determine, based on the spatial distribution, a position of the particle along the section of the nanochannel. For instance, the position of the particle along the section of the nanochannel may be related to the amount of light scattered. In other words, the position of the particle may be a portion of the section of the nanochannel, which scatters more light than other portions of the nanochannel. Alternatively, the position of the particle may be a portion of the section of the nanochannel, which scatters less light than other portions of the nanochannel.

The optics may comprise a microscope. The wording “microscope” should, within the context of this application, be construed as an instrument configured to create an enlarged image of an object. For instance, the microscope may be configured to create an enlarged image of the nanochannel on the imaging surface of the light sensor.

The microscope may be an optical microscope, a visible light microscope, an infrared microscope, or an ultra-violet microscope. The microscope is preferentially an optical microscope. It is to be understood that the type of microscope used in the system may be determined by the wavelength of the light source.

The system may further comprise optics arranged to image the section of the nanochannel on a portion of the imaging surface of the light sensor.

The system may further comprise: a reference nanochannel configured to receive a reference fluid, wherein the reference fluid does not comprise a particle; wherein the light source may be further configured to illuminate the reference nanochannel; wherein the optics may be further arranged to image a section of the reference nanochannel on a further portion of the imaging surface, the further portion of the imaging surface being different from the portion of the imaging surface; wherein the light sensor may be further arranged to determine a reference amount of scattered light from the section of the reference nanochannel, the light being scattered by the section of the reference nanochannel and the reference fluid in the section of the reference nanochannel, and to output reference data based on the reference amount of scattered light; and wherein the processing unit may be further arranged to communicate with the light sensor to receive the reference data, and to determine the presence of the particle in the fluid in the section of the nanochannel based on the received data and the received reference data.

An associated advantage is that a more precise determination of the presence of the particle may be allowed, since the received reference data (i.e., data associated with the reference amount of scattered light) may be removed (e.g. subtracted) from the received data (i.e., data associated with the amount of scattered light from the section of the nanochannel).

The processing unit may be configured to create a digital representation of the imaged section of the nanochannel based on the received data and a reference digital representation of the imaged section of the reference nanochannel based on the received reference data.

An associated advantage is that the digital representation and the reference digital representation may be stored and/or processed in a digital manner. Processing the digital representation of the imaged section of the nanochannel and the reference digital representation of the imaged section of the reference nanochannel in a digital manner is beneficial, since digital processing may increase the sensitivity and/or accuracy of the system.

The processing unit may be further configured to determine, based on the digital representation and the reference digital representation, a spatial distribution of the scattered light from the section of the nanochannel.

By determining the spatial distribution of the scattered light from the section of the nanochannel based on the digital representation and the reference digital representation, a background signal level (i.e., associated with the amount of light scattered from the reference nanochannel) in the spatial distribution may be reduced.

An associated advantage is that spatial information of the section of the nanochannel, the fluid in the section of the nanochannel, and/or, if present in the section of the nanochannel, the particle may be extracted from the digital representation. A further associated advantage is that the amount of scattered light from the section of the nanochannel may be correlated with spatial positions of the section of the nanochannel. In other words, it may be possible to determine portions of the section of the nanochannel, which scatters more light than other portions of the section of the nanochannel.

The processing unit may be further configured to determine, based on the spatial distribution, a position of the particle in the section of the nanochannel.

By determining which portions of the section of the nanochannel that scatters more/less light, it may be possible to determine the position of the particle in the section of the nanochannel. For instance, the position of the particle may be a portion of the section of the nanochannel, which scatters more light than other portions of the nanochannel. Alternatively, the position of the particle may be a portion of the section of the nanochannel, which scatters less light than other portions of the nanochannel.

The processing unit may be further configured to determine a polarizability of the particle based on a distribution of contrast levels of the spatial distribution.

An associated advantage is that properties about the particle may be determined. Such properties may, e.g., be used to detect the presence of specific particles in a fluid sample present in the nanochannel.

The system may be configured to determine a plurality of spatial distributions of scattered light from the section of the nanochannel pertaining to different points in time, and wherein the processing unit may be further configured to determine a size of the particle based on the plurality of spatial distributions.

An associated advantage is that properties about the particle may be determined. Such properties may, e.g., be used to detect the presence of specific particles in a fluid sample present in the nanochannel.

The light source, the light sensor, and the optics may be arranged for dark-field microscopy of the nanochannel. In other words, light that is not scattered from the nanochannel may not reach the light sensor.

The wording “dark-field microscopy” is commonly known as a microscopy technique in which a sample is illuminated with light that does not reach the light sensor directly. In other words, dark-field microscopy only captures light scattered by the imaged object, e.g., a nanochannel. There are several configurations suitable for dark-field microscopy. For instance, a center of a light beam emitted from the light source may be blocked, such that only an outer ring of the light beam illuminates the object. The optics of a dark-field microscope is typically arranged such that light transmitted through the sample (i.e., light not scattered by the sample) does not reach the light sensor. In another example of dark-field microscopy arrangement, the light source may be arranged for shallow-angle illumination of the nanochannel, such that specularly reflected light does not reach the light sensor. Yet another example of dark-field microscopy may be total internal reflection microscopy, in which the nanochannel, the fluid, and the particle are illuminated by an evanescent field.

An advantage of arranging the light source, the light sensor, and the optics for dark-field microscopy of the nanochannel is that unscattered light may not reach the light sensor and will thereby be excluded from the data outputted from/registered by the light sensor. A further advantage of arranging the light source, the light sensor, and the optics for dark-field microscopy of the nanochannel is that only or substantially only scattered light may be used to form the digital representation, e.g., a digital image, of the imaged nanochannel.

The light source may be arranged to directly illuminate an outside of the nanochannel. The light source may be arranged to directly illuminate at least a portion of an outside of the nanochannel. The light source may be arranged to directly illuminate the outside of the nanochannel from an outside of the nanochannel. The light source may be arranged to directly illuminate an outside of the nanochannel from at least one direction.

Within the context of this application, the wording “directly illuminate” should be construed as an arrangement where the light source is positioned outside the nanochannel and light emitted from the light source impinges on an outside of the nanochannel. Such an arrangement is to be distinguished from an arrangement where the light source is arranged to couple light into the nanochannel, as is usually the case for an optical fiber. It is also to be understood that the light emitted from the light source may pass through additional optical components, e.g., filters, lenses and/or windows, prior to impinging the nanochannel.

A thickness and/or a width of the nanochannel may be less than a wavelength of light emitted from the light source.

Within the context of this application, the wordings “thickness” and “width” of a nanochannel should be construed as transverse spatial extensions of said nanochannel.

In case the light source is polychromatic, the thickness and/or the width may be smaller than the longest wavelength of light emitted from the light source. The thickness and/or the width of the nanochannel may preferentially be less than 500 nm. The thickness and/or the width of the nanochannel may even more preferentially be less than 200 nm. For example, the nanochannel may have a width in a range of 10 nm to 100 nm.

At least a portion of the section of the nanochannel may at its inner wall comprise a functionalized layer, wherein the functionalized layer is arranged to bind the particle to the functionalized layer.

The functionalized layer may be arranged to bind particles having specific properties. For example, a first type of particles having specific properties may bind to the functionalized layer, while a second type of particles having different properties may not bind to the functionalized layer.

An advantage of a portion of the section of the nanochannel at its inner wall comprising a functionalized layer, wherein the functionalized layer is arranged to bind the particle to the functionalized layer, is that it may allow for an improved detection of particles having specific properties.

According to a second aspect of the present concepts, a method for determining a presence of a particle in a fluid is provided. The method comprises: receiving the fluid at a nanochannel, wherein the fluid comprises a particle; illuminating the nanochannel; determining an amount of scattered light from a section of the nanochannel, the light being scattered by the nanochannel, the fluid in the section of the nanochannel, and, if present in the section of the nanochannel, the particle; and determining the presence of the particle in the fluid in the section of the nanochannel based on the determined amount of scattered light.

The above-mentioned features and advantages of the system, when applicable, apply to this second aspect as well. In order to avoid undue repetition, reference is made to the above.

The act of determining the presence of the particle in the fluid in the section of the nanochannel based on the determined amount of scattered light may further comprise comparing an amount of scattered light pertaining to a first point in time with an amount of scattered light pertaining to a second point in time. In other words, the presence of the particle in the fluid in the section of the nanochannel may be determined based on a differential amount or relative change of scattered light from the nanochannel.

The method may further comprise: imaging the section of the nanochannel on an imaging surface of a light sensor; and creating a digital representation of the section of the nanochannel being imaged on the imaging surface of the light sensor.

The method may further comprise: creating a spatial distribution of the scattered light from the section of the nanochannel based on the digital representation.

The method may further comprise: determining a position of the particle along the section of the nanochannel based on the digital representation.

The method may further comprise: illuminating a reference nanochannel, wherein the reference nanochannel does not comprise a particle; determining a further amount of scattered light being scattered from the reference nanochannel; and wherein the act of determining the presence of the particle in the fluid in the section of the nanochannel is further based on a comparison of the amount of scattered light from the section of the nanochannel and the further amount of scattered light from the reference nanochannel.

The reference nanochannel may be of the same type as the nanochannel. The further amount of scattered light may be a reference amount of scattered light.

In the act of determining the presence of the particle in the fluid in the section of the nanochannel, the comparison of the amount of scattered light from the section of the nanochannel and the further amount of scattered light from the reference nanochannel may be a ratio according to:

$$\frac{{I}_{2}^{m} / {I}_{1}^{m}}{{I}_{2}^{r} / {I}_{1}^{r}} ,$$

where I₁^{m} and I₂^{m} is the amount of scattered light from the section of the nanochannel at a first and a second point in time, respectively, and I₁^{r} and I₂^{r} is the amount of further scattered light from the reference nanochannel at the first and the second point in time, respectively.

A further scope of applicability of the present disclosure will become apparent from the detailed description given below. However, it should be understood that the detailed description and specific examples, while indicating preferred variants of the present inventive concept, are given by way of illustration only, since various changes and modifications within the scope of the inventive concept will become apparent to those skilled in the art from this detailed description.

Hence, it is to be understood that this inventive concept is not limited to the particular steps of the methods described or component parts of the systems described as such method and system may vary. It is also to be understood that the terminology used herein is for purpose of describing particular embodiments only and is not intended to be limiting. It must be noted that, as used in the specification and the appended claim, the articles “a”, “an”, “the”, and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings do not exclude other elements or steps.

### BRIEF DESCRIPTION OF THE DRAWINGS

The above and other aspects of the present disclosure will now be described in more detail, with reference to appended drawings showing embodiments. The figures should not be considered limiting the invention to the specific embodiment; instead they are used for explaining and understanding the concepts.

As illustrated in the figures, the sizes of layers and regions are exaggerated for illustrative purposes and, thus, are provided to illustrate the general structures of embodiments of the present invention. Like reference numerals refer to like elements throughout.

FIG. 1A illustrates a system adapted to detect a presence of a particle in a fluid utilizing dark-field illumination of a nanochannel.

FIG. 1B illustrates a nanochannel, with a rectangular cross-section, filled with a fluid comprising a particle.

FIG. 2 illustrates a system adapted to detect a presence of a particle in a fluid utilizing dark-field microscopy.

FIG. 3 is a block scheme of a method for determining a presence of a particle in a fluid.

FIG. 4A illustrates a sample nanochannel and a reference nanochannel at a first point in time.

FIG. 4B illustrates the sample nanochannel and the reference nanochannel of FIG. 4A at a second point in time.

FIG. 5A illustrates a spatial distribution of a digital representation of an imaged section of a nanochannel.

FIG. 5B illustrates a spatial distribution determined based on a difference between the digital representation (illustrated as the spatial distribution in FIG. 5A) of the imaged section of the nanochannel and a reference digital representation of an imaged section of a reference nanochannel.

FIG. 6 illustrates a timelapse image based on a plurality of spatial distributions.

### DETAILED DESCRIPTION

The present concepts will now be described more fully hereinafter with reference to the accompanying drawings, in which currently preferred variants of the concepts are shown. This concepts may, however, be implemented in many different forms and should not be construed as limited to the variants set forth herein; rather, these variants are provided for thoroughness and completeness, and fully convey the scope of the present concepts to the skilled person.

There are a number of applications and/or methods which may benefit from the present inventive concept, for instance affinity biosensing, electrophoresis, methods to study catalytic reactions, and methods to study dynamics of particles inside solutions.

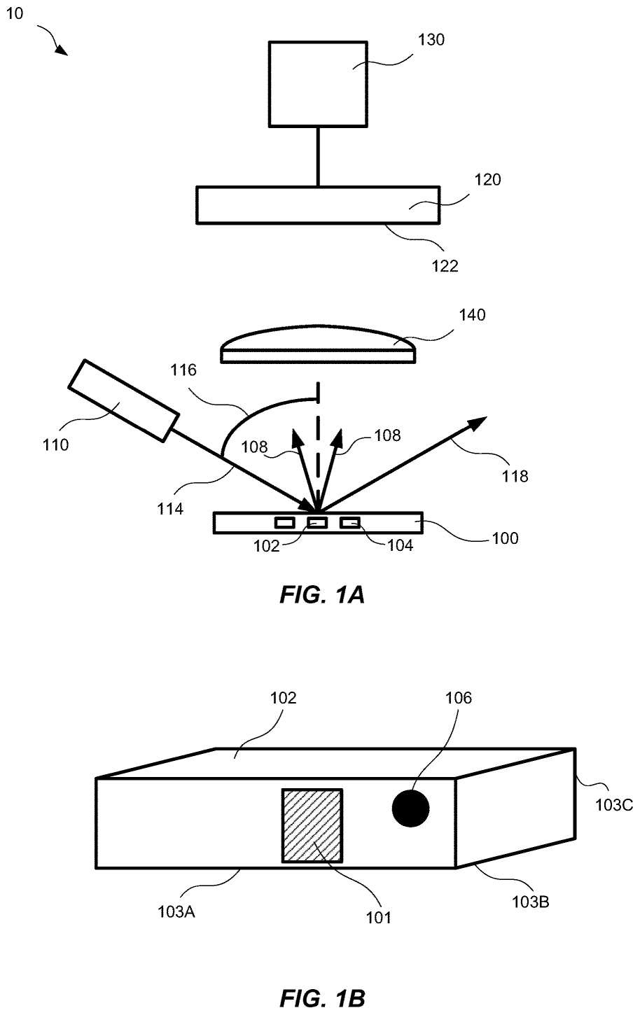

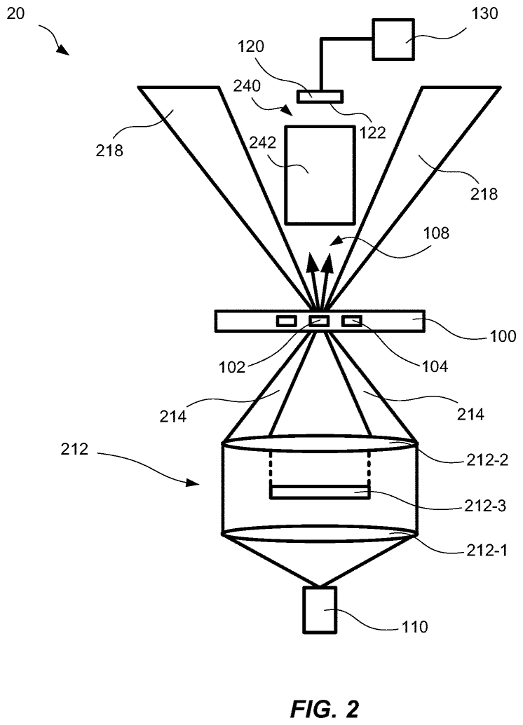

The illustrations in FIG. 1A and FIG. 2 indicate that only a single nanochannel is illuminated, however this is for illustrational purposes only, and multiple nanochannels may be illuminated simultaneously.

FIG. 1A illustrates a system 10 adapted to detect a presence of a particle in a fluid utilizing dark-field illumination of a nanochannel. The system 10 depicted in FIG. 1A comprises a nanochannel 102 embedded in a substrate 100, a light source 110, a light sensor 120, and a processing unit 130. The nanochannel 102 in FIG. 1A will be described in greater detail in relation to FIG. 1B. The substrate 100 may be made of a dielectric material, for example SiO₂. Alternatively, the substrate may be made of other materials such as Si, SiNₓ, Al₂O₃, TiO₂, quartz, and/or polymers. The substrate may be made of an IR transparent material. The nanochannel 102 is configured to receive a fluid, and the fluid comprises a particle. The fluid is, in this case, H₂O, but there are a plurality of different liquids and gases that may be fed to and consequently received by the nanochannel 102. For example, one or more of water, buffer, ethanol, an organic solvent, serum, cytoplasm, aqueous solutions of salts, air, argon, helium, hydrogen, NO, NO₂, and CO may be the fluid received by the nanochannel 102. The particle 106 as illustrated in FIG. 1B may be a metal nanoparticle. However, there are a plurality of different particles that may be comprised in the fluid. For example, the particle 106 may be an organic or inorganic molecule, a biological macromolecule, a bubble in the fluid, and/or a dielectric nanoparticle. The particle 106 may have a size in a range of 5 nm to 100 nm. It is here understood that the size of the particle 106 may be smaller than the width of the nanochannel 102.

The light source 110 is arranged to illuminate the nanochannel 102. In the example shown in FIG. 1A, the light source 110 is a laser emitting coherent light at a wavelength of 532 nm. Alternatively, the light source 110 may be of a different type and emit quasi-coherent or incoherent light of monochromatic or polychromatic wavelength. The light source 110 may, for instance, be a superluminescent diode, a supercontinuum laser, or a halogen lamp. The light emitted from the light source 110 may pass through a beam expander in order to illuminate a large area of the substrate 100. An incident beam of light 114 impinges directly on a section of the nanochannel 102 at an incident angle 116. In other words, the light source 110 is arranged to directly illuminate an outside of the section of the nanochannel 102. In other words, the outside of the section of the nanochannel 102 is not illuminated from within the section of the nanochannel 102. The incident beam of light 114 is partly scattered by the section of the nanochannel 102, the fluid in the section of the nanochannel 102, and, if present in the section of the nanochannel 102, the particle 106. A part of the scattered light 108 is collected by optics, for example by a lens 140. In other words, the scattered light 108 comprises light being scattered by the section of the nanochannel 102, by the fluid in the section of the nanochannel 102, and, if present in the section of the nanochannel 102, by the particle 106. In case the presence of the particle 106 is to be determined in prior art systems, light scattered from the nanochannel 102 and/or the fluid will generally have to be blocked. However, such blocking is not needed in the present system 10 described here. Instead, the part of the scattered light 108 collected by the lens 140 comprises light scattered by the section of the nanochannel 102, by the fluid in the section of the nanochannel 102, and, if present in the section of the nanochannel 102, by the particle 106.

The light sensor 120 is arranged to determine an amount of scattered light 108 from the section of the nanochannel 102. The light sensor 120 is further arranged to output data based on the amount of scattered light. In the example shown in FIG. 1A, the lens 140 is arranged to image the section of the nanochannel 102 on an imaging surface 122 of the light sensor 120. The lens 140 (optics) may be arranged to image the section of the nanochannel 102 on a portion of the imaging surface 122 of the light sensor 120.

Alternatively, the optics may comprise different types and combinations of optical elements, such as a window, a filter, a diaphragm, a camera objective, a zoom objective, and/or a microscope. A system utilizing dark-field microscopy will be described in relation to FIG. 2A. In other words, it is to be understood that the lens 140 shown in FIG. 1A may be exchanged for other optics. The optics may also be omitted.

As it is seen in FIG. 1A, the incident light beam 114 may be partly reflected on the section of the nanochannel 102. Further, the nanochannel 102, the light source 110, and the light sensor 120 are arranged such that the beam of reflected light 118 does not reach the light sensor 120. In other words, the light that reaches the light sensor 120 comprises a part of the scattered light 108 and not the reflected light 118. The light sensor 120 in FIG. 1A outputs data based on an amount of the scattered light 108 that reaches the light sensor 120. The data may be based on an intensity of the scattered light 108 that reaches the light sensor 120. It is to be understood that, even though not explicitly shown in FIG. 1A, the incident light beam 114 may be partly transmitted through the substrate 100.

The processing unit 130 is arranged to communicate with the light sensor 120, and to receive the data based on the amount of scattered light 108 from the section of the nanochannel 102 that reaches the light sensor 120. In the example shown in FIG. 1A, the light sensor 120 and the processing unit 130 are connected via a wired connection such as USB. However, the skilled person realizes that there is a plurality of different wired and wireless alternatives to use for the communication. In the example shown in FIG. 1A, the processing unit 130 is configured to create a digital representation of the imaged section of the nanochannel 102 based on the received data.

The processing unit 130 is arranged to determine the presence of the particle 106 in the fluid in the section of the nanochannel 102 based on the received data. For instance, the presence of the particle 106 in the section of the nanochannel 102 may be determined as when the amount of scattered light 108 from the section of the nanochannel 102 that reaches the light sensor 120 is above or below a predetermined threshold value. The processing unit 130 may be further arranged to determine the presence of the particle 106 in the fluid in the section of the nanochannel 102 based on a change of the received data. The change of the received data may correspond to a difference between a first and a second amount of scattered light 108 from the section of the nanochannel 102. The first/second amount of scattered light 108 may be scattered light from a first/second portion of the section of the nanochannel 102. The first/second amount of scattered light 108 may be scattered light from a portion of the section of the nanochannel 102 at a first/second point in time. In other words, the presence of the particle 106 in the fluid in the section of the nanochannel 102 may be based on a relative change or differential amount of scattered light from the section of the nanochannel 102.

The processing unit 130 may further be arranged to determine the presence of the particle 106 by comparing the data based on the amount of scattered light 108 pertaining to a first point in time with the data based on the amount of scattered light 108 pertaining to a second point in time. In other words, the presence of the particle 106 in the section of the nanochannel 102 may be determined based on a relative change or differential amount of scattered light 108 from the nanochannel 102.

The processing unit 130 may further be configured to determine a spatial distribution of the scattered light 108 from the section of the nanochannel 102 that reaches the light sensor 120 based on the digital representation. For instance, the spatial distribution of the scattered light 108 from the section of the nanochannel 102 that reaches the light sensor 120 may be a digital image of the section of the nanochannel 102. In case the processing unit 130 is configured to determine a spatial distribution of the scattered light 108 from the section of the nanochannel 102 that reaches the light sensor 120, a position of the particle 106 along the section of the nanochannel 102 may be determined by the processing unit 130.

The presence of the particle 106 in the fluid in the section of the nanochannel 102 may also be detected based on a comparison with a reference amount of scattered light 108 that reaches the light sensor 120. For instance, a reference nanochannel 104 that does not comprise a particle may be used to determine a reference amount of scattered light 108 that reaches the light sensor 120. The nanochannel 102 may also be referred to as the sample nanochannel 102. Intensity variations of the light source 110 may thereby be accounted for when determining the presence of the particle 106 in the fluid in the section of the nanochannel 102. The reference nanochannel 104 may be configured to receive a reference fluid, wherein the reference fluid does not comprise a particle. The light source 110 may be further configured to illuminate the reference nanochannel 104. The optics 140 may be further arranged to image a section of the reference nanochannel 104 on a further portion of the imaging surface 122, the further portion of the imaging surface 122 being different from the portion of the imaging surface 122 (i.e., the portion of the imaging surface 122 that the portion of the nanochannel 102 may be imaged onto). The light sensor 120 may be further arranged to determine a reference amount of scattered light from the section of the reference nanochannel 104, the light being scattered by the section of the reference nanochannel 104 and the reference fluid in the section of the reference nanochannel, and to output reference data based on the reference amount of scattered light. In FIG. 1A, the scattered light 108 from the nanochannel 102 is shown, however, even though not explicitly shown in FIG. 1A, the reference nanochannel 104 will scatter light in a similar manner. The light scattered from the reference nanochannel 104 is not depicted in FIG. 1A in order to increase the legibility of FIG. 1A.

The processing unit 130 may be further arranged to communicate with the light sensor 120 to receive the reference data, and to determine the presence of the particle 106 in the fluid in the section of the nanochannel 102 based on the received data and the received reference data.

The processing unit 130 may be configured to create a digital representation of the imaged section of the nanochannel 102 based on the received data and a reference digital representation of the imaged section of the reference nanochannel 104 based on the received reference data. The digital representation and the reference digital representation may be separate portions of a common digital representation (e.g., a digital image).

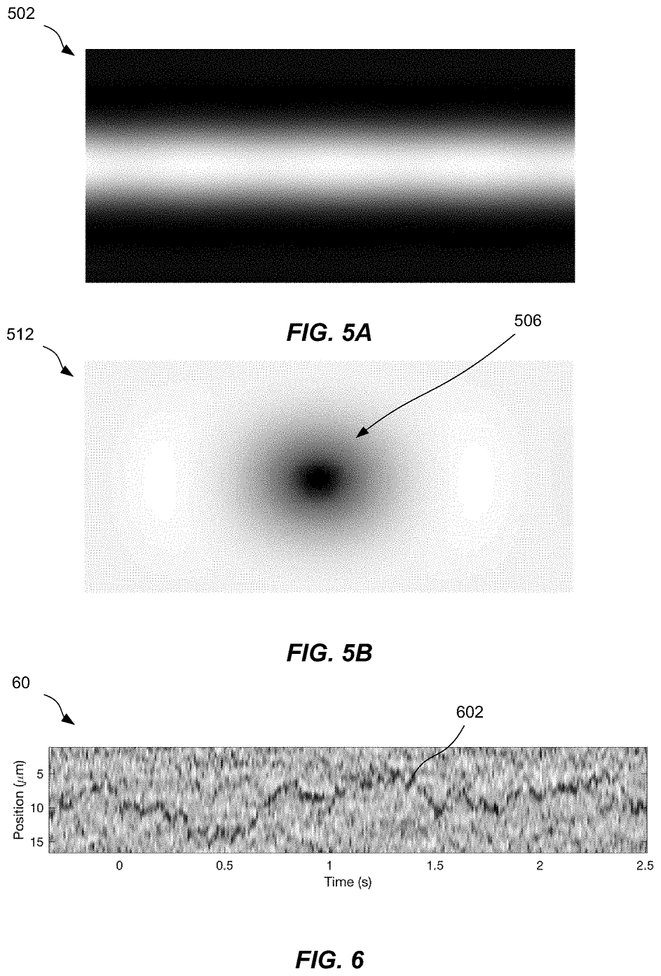

An example of a spatial distribution 502 of a digital representation of the imaged section of the nanochannel 102 is shown in FIG. 5A. The horizontal direction in FIG. 5A represents the longitudinal extension of the section of the nanochannel 102, and the vertical direction in FIG. 5A represents the transversal extension of the section of the nanochannel 102. A spatial distribution (not shown) of a reference digital representation of the imaged section of the reference nanochannel 104 may be similar to the spatial distribution 502 of the digital representation of the imaged section of the nanochannel 102 shown in FIG. 5A.

The processing unit 130 may be further configured to determine, based on the digital representation and the reference digital representation, a spatial distribution 512 of the scattered light from the section of the nanochannel 102. The processing unit 130 may be further configured to determine, based on the spatial distribution 512, a position of the particle 106 in the section of the nanochannel 102.

FIG. 5B illustrates a spatial distribution 512 which is determined based on a difference between the digital representation (illustrated as the spatial distribution 502 in FIG. 5A) of the imaged section of the nanochannel 102 and the reference digital representation (not shown) of the imaged section of the reference nanochannel 104. The spatial distribution may be determined based on a ratio of the digital representation of the imaged section of the nanochannel 102 and the reference digital representation of the imaged section of the reference nanochannel 104. Just like in FIG. 5A, the horizontal direction in FIG. 5B represents the longitudinal extension of the section of the nanochannel 102, and the vertical direction in FIG. 5B represents the transversal extension of the section of the nanochannel 102. In other words, the background signal level (i.e., associated with the signal level of the reference digital representation of the imaged section of the reference nanochannel 104) is subtracted from the signal level of the digital representation (i.e., associated with the signal level of the digital representation of the imaged section of the nanochannel 102) when determining the spatial distribution 512 of FIG. 5B. The presence, as well as the position, of the nanoparticle 106 in the section of nanochannel 102 is clearly seen in FIG. 5B as a dark spot 506.

In case the spatial distribution 512 is determined based on a difference between the digital representation of the imaged section of the nanochannel 102 and the reference digital representation of the imaged section of the reference nanochannel 104, the processing unit 130 may be further configured to determine a polarizability of the particle 106 based on a distribution of contrast levels of the spatial distribution 512. As is seen in FIG. 5B, the contrast (intensity contrast) of the spatial distribution 512 varies, and the weight (molecular weight) of the particle may be determined from the varying contrast. A polarizability of the particle 106 may be determined from the contrast of FIG. 5B (using Eq. 3).

In case the spatial distribution is determined based on a ratio of the digital representation of the imaged section of the nanochannel 102 and the reference digital representation of the imaged section of the reference nanochannel 104, the processing unit 130 may be further configured to determine a polarizability of the particle 106 based on distribution of a normalized signal change, Δ̅I̅, using Eq. 3 and Eq. 6.

As is known in the art, the polarizability of the particle 106 may be dependent on the particle size and refractive indices of the particle and its surroundings (i.e., the surrounding fluid in the section of the nanochannel 102). In case the particle is a biomolecule (e.g., protein), it can be assumed that the polarizability is linearly dependent on molecular weight of the particle 106. The molecular weight of an unknown biomolecule may then be determined from a calibration curve. The calibration curve may be determined using biomolecules of known molecular weight. The calibration curve may thereby comprise information regarding how the known molecular weight of the biomolecules depend on intensity contrast in spatial distributions associated with the biomolecules of known molecular weight.

The system 10 may be configured to determine a plurality of spatial distributions 512 of scattered light from the section of the nanochannel 102 pertaining to different points in time. The processing unit 130 may be further configured to determine a size of the particle 106 based on the plurality of spatial distributions 512. The diffusivity of the particle 106 may be determined from a measured spatial displacement of the particle 106 over time using methods known in the art. A radius of the particle 106 (in case the particle 106 is a biomolecule, the radius may be referred to as the hydrodynamic radius) may be inversely proportional to its diffusivity. The size of the particle 106 can then be determined from a calibration curve. The calibration curve may be determined using particles (e.g., biomolecules) of known sizes. The calibration curve may thereby comprise information regarding how the known particle sizes depend on diffusivity. FIG. 6 illustrates a timelapse image (kymograph) which is based on a plurality of spatial distributions of scattered light from a nanochannel, and where each spatial distribution corresponds to a point in time. In this example, the particle is a protein having a radius of 6 nm and a molecular weight of 65 kDa. The horizontal axis of FIG. 6 corresponds to time, and the vertical axis of FIG. 6 corresponds to a longitudinal position in the nanochannel. Each column in FIG. 6 corresponds to a transverse average of a spatial distribution for the point in time associated with each respective row. By transverse average here is meant that the average spatial distribution along a dimension corresponding to the transverse direction of the nanochannel is determined. Thereby, resulting in an array image. For example, if the spatial distribution has a pixel resolution of m×n, then the transverse average may have pixel resolution of 1×n or m×1 (depending on which dimension corresponds to the transverse direction of the nanochannel). In other words, the dark line 602 visible in FIG. 6 corresponds to the trajectory of the particle as it flows and diffuses through the nanochannel. By tracking the position of the particle in FIG. 6 as a function of time, its diffusivity may be determined. As is known within the art, by knowing the particle diffusivity, the particle size may be determined.

FIG. 1B illustrates a schematic representation of the sample nanochannel 102 of the system 10 illustrated in FIG. 1A. The sample nanochannel 102 may, as is illustrated in FIG. 1B, have a rectangular cross section. The nanochannel 102 has received the fluid comprising the particle 106. In other words, the nanochannel 102 is filled with the fluid comprising the particle 106. The nanochannel 102 may be filled from a container coupled to the nanochannel 102, the container comprising the fluid. The container may be a microfluidic channel. A width 103B and a height 103C of the sample nanochannel 102 are smaller than the wavelength of light emitted by the light source 110. Further, a length 103A of the sample nanochannel may be arbitrary, typically larger than the wavelength of light emitted by the light source 110. The nanochannel 102 may have different cross section than rectangular, e.g., a square cross section, an elliptical cross section, or a circular cross section. However, the dimensions of the cross section are preferably smaller than the wavelength of light emitted by the light source 110. At least a portion of an inner wall of the sample nanochannel 102 may comprise an additional layer. The additional layer may comprise a biofunctional layer, catalytic particles, photoactive molecules, polymer molecules, and/or a functional oxide. The additional layer may comprise metal particles which, upon illumination with light/electromagnetic radiation, allow a localized plasmon resonance condition. Such metal particles may, within the art, be referred to as plasmonic particles.

At least a portion of the section of the nanochannel 102 may, as exemplified in FIG. 1B, at its inner wall comprise a functionalized layer 101, wherein the functionalized layer 101 is arranged to bind the particle 106 to the functionalized layer 101. The functionalized layer 101 may be arranged to bind particles having specific properties. For example, a first type of particles having specific properties may bind to the functionalized layer 101, while a second type of particles having different properties may not bind to the functionalized layer 101.

In case of using a reference nanochannel 104, the reference nanochannel 104 preferably has dimensions such that the amount of scattered light from the reference nanochannel 104 is similar to the amount of scattered light from the sample nanochannel 102.

FIG. 2 illustrates a system 20 arranged to detect a presence of a particle in a fluid utilizing dark-field microscopy. The system 20 comprises a nanochannel 102 embedded in a substrate 100, a light source 110, a light sensor 120, and a processing unit 130. The substrate 100 in FIG. 2 corresponds to the substrate 100 described in relation to FIG. 1A. The nanochannel 102 is configured to receive a fluid comprising a particle 106. In other words, the nanochannel 102 is filled with the fluid comprising the particle 106. Further details relating to the substrate 100 and the nanochannel 102 are not repeated here, as they are similar to the description in relation to FIG. 1A and FIG. 1B. Reference is therefore made to the above.

The system 20 further comprises an optics arrangement 212 and a microscope objective 242. The optics arrangement 212 is configured to block a portion of light emitted from the light source 110. The portion may be a center portion of light emitted from the light source 110. In the example shown in FIG. 2, the optics arrangement 212 comprises a first lens 212-1, a second lens 212-2, and a light stop 212-3. The first lens 212-1 may be configured to collimate light emitted from the light source 110. The light stop 212-3 may be configured to block the center portion of light emitted from the light source 110, leaving an outer ring of light. The second lens 212-2 may be configured to focus the outer ring of light. Light after the second lens 212-2 will from here on be referenced to as the incident light 214. It is to be understood that the optics arrangement 212 may comprise additional optical components not included here.

The incident light 214 impinges on the nanochannel 102 and directly illuminates an outside of a section of the nanochannel 102 from outside of the section of the nanochannel 102. In FIG. 2, the incident light 214 is shown as impinging on the nanochannel 102, however, even though not explicitly shown in FIG. 2, the incident light may further impinge/illuminate the reference nanochannel 104. The light scattered from the reference nanochannel 104 is not depicted in FIG. 2 in order to increase the legibility of FIG. 2. The incident light 214 is partly transmitted through the substrate 100 without any scattering. The light transmitted through the substrate 100 without any scattering will from here on be referenced to as the transmitted light 218. The light sensor 120 is arranged such that transmitted light 218 do not reach the light sensor 120. Hence, since the center of the collimated light has been blocked, the transmitted light 218 does not reach the light sensor 120. The microscope objective 242 is arranged to image the section of the nanochannel 102 on an imaging surface 122 of the light sensor 120. A part of the incident light 214 is scattered by the section of the nanochannel 102, by the fluid in the section of the nanochannel 102, and, if present in the section of the nanochannel 102, by the particle 106. A part of the scattered light 108 from the section of the nanochannel 102 is captured by the microscope objective 242. Thus, the part of the scattered light 108 from the section of the nanochannel 102 reaching the microscope objective 242 is used when imaging the section of the nanochannel 102 on the imaging surface 122. In other words, the image of the section of the nanochannel 102 on the imaging surface 122 comprises only scattered light.

The light sensor 120 and the processing unit 130 in FIG. 2 corresponds to the respective components in FIG. 1A, and details relating to them will not be repeated here, as the details will be similar as to the description in relation to FIG. 1A. Reference is therefore made to the above.

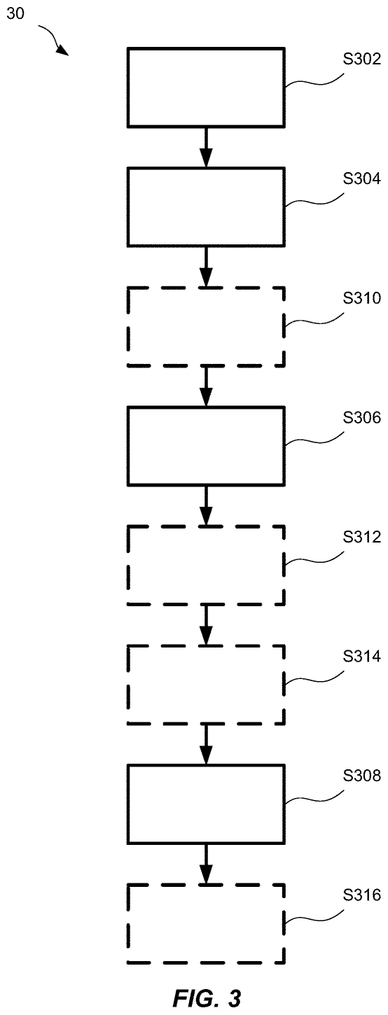

A method 30 for determining a presence of a particle in a fluid in a section of a nanochannel 102 will now be described with reference to FIG. 3. The method 30 comprises the following steps or acts:

Receiving S302 the fluid at a nanochannel 102, wherein the fluid comprises a particle 106.

Illuminating S304 the nanochannel 102. The nanochannel 102 may be directly illuminated on an outside thereof. In other words, the nanochannel 102 may be directly illuminated on an outside of the nanochannel 102 from outside of the nanochannel 102. The nanochannel 102 may be illuminated by the light source 110.

Determining S306 an amount of scattered light 108 from a section of the nanochannel, the light being scattered by the nanochannel 102, the fluid in the section of the nanochannel 102, and, if present in the section of the nanochannel 102, the particle 106. The amount of scattered light 108 may be determined by the light sensor 120.

Determining S308 the presence of the particle 106 in the fluid in the section of the nanochannel 102 based on the determined amount of scattered light 108. The presence of the particle 106 may be determined by the amount of scattered light 108 being above or below a threshold value.

The method 30 may further comprise imaging S310 the section of the nanochannel 102 on an imaging surface 122 of a light sensor 120 and creating S312 a digital representation of the section of the nanochannel 102 being imaged on the imaging surface 122 of the light sensor 120.

The method 30 may further comprise creating S314 a spatial distribution of the scattered light 108 from the section of the nanochannel 102 based on the digital representation.

The method 30 may further comprise determining S316 a position of the particle 106 along the section of the nanochannel 102 based on the digital representation.

The method 30 may further comprise illuminating a reference nanochannel 104, wherein the reference nanochannel 104 does not comprise a particle 106.

The method 30 may further comprise determining a further amount of scattered light being scattered from the reference nanochannel 104. The further amount of scattered light being scattered from the reference nanochannel 104 may be determined by the light sensor 110. The further amount of scattered light being scattered from the reference nanochannel 104 may be determined by the light sensor 110 at the same point in time as the amount of scattered light from the section of the nanochannel 102 is determined S306.

The act of determining S308 the presence of the particle 106 in the fluid in the section of the nanochannel 102 may be further based on a comparison of the amount of scattered light 108 from the section of the nanochannel 102 and the further amount of scattered light from the reference nanochannel 104.

The skilled person realizes that even though the method 30 has been described in a consecutive manner, several acts may be performed simultaneously or in a different order than described here. For instance, the act of illuminating S304 the nanochannel 102 may be performed prior to receiving S302 the fluid comprising the particle 106 at the nanochannel 102.

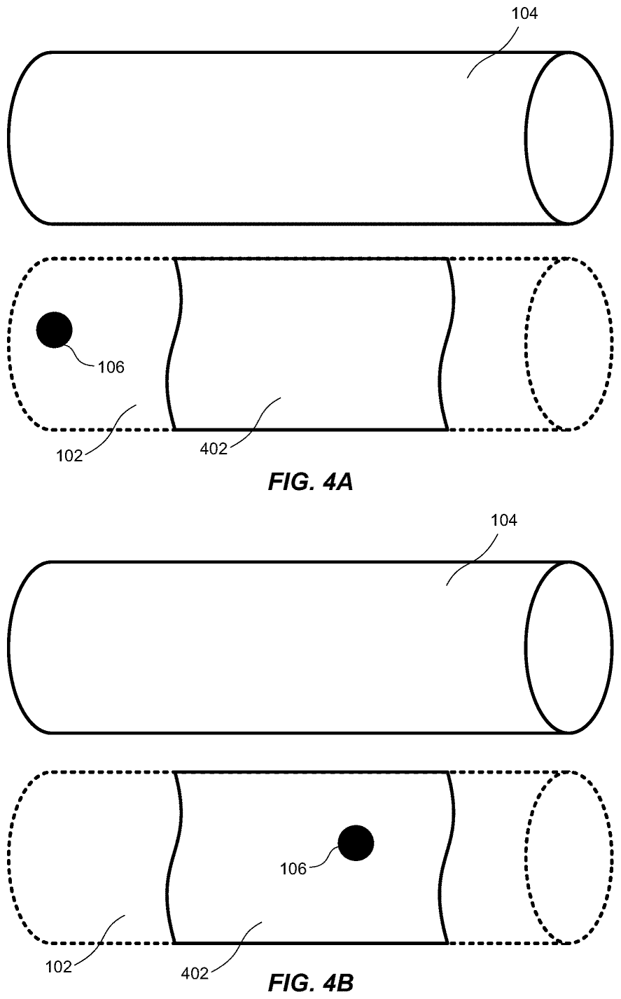

The determination of the presence of the particle 106 in the fluid in the section 402 of the nanochannel 102 will now be described with reference to FIG. 4A and FIG. 4B.

FIG. 4A illustrates a reference nanochannel 104 and a sample nanochannel 102 having circular cross-sections at a first point in time. The reference nanochannel 104 and the sample nanochannel 102 may be nanochannels embedded in the substrate 100 described in relation to FIG. 1A and FIG. 2. A further amount of scattered light from the reference nanochannel 104 may be used to determine intensity variations of the light source 110.

The nanochannel 102 in FIG. 4A has received the fluid comprising the particle 106. In FIG. 4A, a first amount, I₁^{m}, of scattered light from a section 402 of the nanochannel 102 may be determined. The first amount of scattered light from the section 402 of the nanochannel 102 comprises light scattered by the section 402 of the nanochannel 102 and by the fluid in the section 402 of the nanochannel 102. Since the particle 106 is not present in the section 402 of the nanochannel 102, the first amount of light scattered from the section 402 of the nanochannel 102 does not comprise light scattered by the particle 106. In other words, the amount of scattered light is not influenced by the particle 106. Simultaneously as determining the first amount of scattered light from the section 402 of the nanochannel 102, a first further amount, I₁^{r}, of scattered light from the reference nanochannel 104 may be determined.

FIG. 4B illustrates the reference nanochannel 104 and the sample nanochannel 102 in FIG. 4A at a second moment in time. In FIG. 4B, a second amount, I₂^{m}, of light scattered from the section 402 of the nanochannel 102 may be determined. The second amount of scattered light from the section 402 of the nanochannel 102 comprises light scattered by the section 402 of the nanochannel 102, by the fluid in the section 402 of the nanochannel 102, and by the particle 106. Simultaneously as determining the second amount of scattered light from the section 402 of the nanochannel 102, a second further amount, I₂^{r}, of scattered light from the reference nanochannel 104 may be determined.

A normalized signal change, Δ̅I̅, may then be determined as a ratio according to:

$$\overline{Δ I} = \frac{{I}_{2}^{m} / {I}_{1}^{m}}{{I}_{2}^{r} / {I}_{1}^{r}} - 1.$$

The presence of the particle 106 in the fluid in the section 402 of the nanochannel 102 may then be determined when the normalized signal change is higher than a threshold value. The threshold value may be a predetermined threshold value. The threshold value may be a multiple of standard deviation of a signal noise level. For example, the threshold value may be three standard deviations of the signal noise level.

It is to be understood that the ratio I₂^{m}/I₁^{m} may be based on a first (I₁^{m}) and a second (If) amount of scattered light determined from different spatial portions of the nanochannel 102. In such case, the first and second amount of scattered light may be determined at the same point in time. The ratio I₂^{r}/I₁^{r} may be determined in a corresponding manner.

The person skilled in the art realizes that the present concepts by no means are limited to the preferred variants described above. On the contrary, many modifications and variations are possible within the scope of the appended claims.

For example, the nanochannel does not need to be embedded in a dielectric material as exemplified in FIG. 1A and FIG. 1B, as it may alternatively be a hollow-core fiber or a capillary.

Additionally, variations to the disclosed variants can be understood and effected by the skilled person in practicing the claimed invention, from a study of the drawings, the disclosure, and the appended claims.

1. A system for label-free determination of a presence of a particle in a fluid, the system comprising:
a nanochannel configured to receive the fluid, wherein the fluid comprises a particle;
a light source, configured to illuminate the nanochannel;
a light sensor, arranged to determine an amount of scattered light from a section of the nanochannel, the light being scattered by the section of the nanochannel, the fluid in the section of the nanochannel, and, if present in the section of the nanochannel, the particle and to output data based on the amount of scattered light; and
a processing unit arranged to communicate with the light sensor to receive the data based on the amount of scattered light, and to determine the presence of the particle in the fluid in the section of the nanochannel based on the received data.

2. The system according to claim 1, wherein the processing unit is further arranged to determine the presence of the particle by comparing the data based on the amount of scattered light pertaining to a first point in time with the data based on the amount of scattered light pertaining to a second point in time.

3. The system according to claim 1, wherein the system further comprises optics arranged to image the section of the nanochannel on an imaging surface of the light sensor.

4. The system according to claim 3, wherein the processing unit is configured to create a digital representation of the imaged section of the nanochannel based on the received data.

5. The system according to claim 4, wherein the processing unit is further configured to determine, based on the digital representation, a spatial distribution of the scattered light from the section of the nanochannel.

6. The system according to claim 5, wherein the processing unit is further configured to determine, based on the spatial distribution, a position of the particle along the section of the nanochannel.

7. The system according to claim 1, wherein the system further comprises optics arranged to image the section of the nanochannel on a portion of an imaging surface of the light sensor.

8. The system according to claim 7, further comprising:
a reference nanochannel configured to receive a reference fluid, wherein the reference fluid does not comprise a particle;
wherein the light source is further configured to illuminate the reference nanochannel;
wherein the optics is further arranged to image a section of the reference nanochannel on a further portion of the imaging surface, the further portion of the imaging surface being different from the portion of the imaging surface;
wherein the light sensor is further arranged to determine a reference amount of scattered light from the section of the reference nanochannel, the light being scattered by the section of the reference nanochannel and the reference fluid in the section of the reference nanochannel, and to output reference data based on the reference amount of scattered light; and
wherein the processing unit is further arranged to communicate with the light sensor to receive the reference data, and to determine the presence of the particle in the fluid in the section of the nanochannel based on the received data and the received reference data.

9. The system according to claim 8, wherein the processing unit is configured to create a digital representation of the imaged section of the nanochannel based on the received data and a reference digital representation of the imaged section of the reference nanochannel based on the received reference data.

10. The system according to claim 9, wherein the processing unit is further configured to determine, based on the digital representation and the reference digital representation, a spatial distribution of the scattered light from the section of the nanochannel.

11. The system according to claim 10, wherein the processing unit is further configured to determine, based on the spatial distribution, a position of the particle in the section of the nanochannel.

12. The system according to claim 10, wherein the processing unit is further configured to determine a polarizability of the particle based on a distribution of contrast levels of the spatial distribution.

13. The system according to claim 10, wherein the system is configured to determine a plurality of spatial distributions of scattered light from the section of the nanochannel pertaining to different points in time, and wherein the processing unit is further configured to determine a size of the particle based on the plurality of spatial distributions.

14. The system according to claim 3, wherein the light source, the light sensor, and the optics are arranged for dark-field microscopy of the nanochannel.

15. The system according to claim 1, wherein the light source is arranged to directly illuminate an outside of the nanochannel.

16. The system according to claim 1, wherein at least a portion of the section of the nanochannel at its inner wall comprises a functionalized layer, wherein the functionalized layer is arranged to bind the particle to the functionalized layer.

17. A method for label-free determination of a presence of a particle in a fluid, the method comprising:
receiving the fluid, at a nanochannel, wherein the fluid comprises a particle;
illuminating the nanochannel;
determining an amount of scattered light from a section of the nanochannel, the light being scattered by the section of the nanochannel, the fluid in the section of the nanochannel, and, if present in the section of the nanochannel, the particle; and
determining the presence of the particle in the fluid in the section of the nanochannel based on the determined amount of scattered light.

18. The method according to claim 17, the method further comprising:
imaging the section of the nanochannel on an imaging surface of a light sensor; and
creating a digital representation of the section of the nanochannel being imaged on the imaging surface of the light sensor.

19. The method according to claim 18, the method further comprising:
creating a spatial distribution of the scattered light from the section of the nanochannel based on the digital representation.

20. The method according to claim 19, the method further comprising:
determining a position of the particle along the section of the nanochannel based on the digital representation.

21. The method according to claim 17, further comprising:
illuminating a reference nanochannel, wherein the reference nanochannel does not comprise a particle;
determining a further amount of scattered light being scattered from the reference nanochannel; and
wherein the act of determining the presence of the particle in the fluid in the section of the nanochannel is further based on a comparison of the amount of scattered light from the section of the nanochannel and the further amount of scattered light from the reference nanochannel.

22. The method according to claim 21, wherein, in the act of determining the presence of the particle in the fluid in the section of the nanochannel, the comparison of the amount of scattered light from the section of the nanochannel and the further amount of scattered light from the reference nanochannel is based on a ratio:
$$\frac{{I}_{2}^{m} / {I}_{1}^{m}}{{I}_{2}^{r} / {I}_{1}^{r}} ,$$
where I₁^{m} and I₂^{m} is the amount of scattered light from the section of the nanochannel at a first and a second point in time, respectively, and I₁^{r} and I₂^{r} is the amount of further scattered light from the reference nanochannel at the first and the second point in time, respectively.
